(19) United States
(12) Patent Application Publication
(10) Pub. No.: US 2013/0052316 A1
(43) Pub. Date: Feb. 28, 2013

(54) METHOD FOR PREPARING A SNACK-TYPE MEAT FOOD PRODUCT

(71) Applicants: Carlos Avilés Rodríguez, Saltillo (MX); Jorge Avilés Rodríguez, Saltillo (MX)

(72) Inventors: Carlos Avilés Rodríguez, Saltillo (MX); Jorge Avilés Rodríguez, Saltillo (MX)

(73) Assignee: INTERNATIONAL FOODS SALTILLO, S. DE R. L. DE C. V., Ramos Arizpe (MX)

(21) Appl. No.: 13/695,270

(22) PCT Filed: Apr. 15, 2011
(86) PCT No.: PCT/MX2011/000047

§ 371 Date: Oct. 29, 2012

(30) Foreign Application Priority Data
Apr. 30, 2010 (MX) MX/A/2010/004826

(51) Int. Cl. A23L 1/31; A23L 1/318; A23L 1/315; A23L 1/325; A23B 4/03; A23P 1/00

(52) U.S. Cl. 426/296; 426/388; 426/641; 426/647; 426/644; 426/643

(57) ABSTRACT

A method for preparing a crunchy snack-type meat food product, the method includes the steps of cutting pieces of muscle into meat strips, cutting in the direction of the muscle fibers of the muscle pieces; pressing the meat strips together in parallel into a mold; freezing the meat strips in the mold to form a frozen block of meat strips; removing the frozen block of meat strips from the mold; slicing the frozen block transversely to the muscle fibers, thereby obtaining sheets or slices of meat; and dehydrating and cooking same.

### TECHNICAL FIELD OF THE INVENTION

The present invention relates to a method for the preparation of foods and particularly to a method for preparing a crunchy snack-type meat food product.

### BACKGROUND OF THE INVENTION

At present, the consumption of snacks has increased significantly, but generally these types of snacks are made with refined flour, which affects the health of consumers when consumed in large amounts. On the other hand, the snack-type food has been known for a long time to be prepared from tubercles such as potatoes, which have been highly appreciated by consumers as a snack, or to serve as an additional with some other food. Additionally, there is abundant literature on how to carry out a method for the preparation of such foods to get a crunchy roasted product with different characteristics of flavor, color, texture, as well as to obtain a product with various food characteristics that are convenient for the general consumer.

Recent dietary and nutritional trends have led many people to reduce their carbohydrate consumption and to eat more proteins. Dry meat sales have benefited from these trends, as consumers seek to replace the traditional starch based snacks like potato chips. Yet, the chewy texture of the meat is not closely associated with the crunchy experience of a fried potato, consequently many consumers still prefer high carbohydrate snack foods instead of meat snacks.

However, there is not much information about a method for the preparation of snack foods prepared from meat, which has a roasted and crunchy texture, as the fat content of meat, normally used as a basis for the preparation for said meat makes it difficult to obtain a product of a roasted and uniform texture, that maintains its food properties and that is pleasant in flavor, color and texture for the consumers.

Jay B. Fox, in the United States patent U.S. Pat. No. 3,497,363 describes a method to prepare a meat snack; whereby the method consists in cutting slices of meat partially frozen in thicknesses of 1.02 mm to 1.78 mm; freezing the meat slices, freeze-drying the slices of frozen meat and frying the freeze-dried slices in a neutral edible oil at a temperature between 150° C. to 150° C. during 15 to 45 seconds.

Selden G. Craker in publication of the United States patent application US-2003/0039727 A1 describes a method to prepare a snack-type food of low fat and cholesterol, with a roasted and crunchy appearance and that is made from a pepperoni type meat. The method involves treating cuts of pepperoni in a first stage of “sweat”, followed by a second stage of “sweat” and a pre-absorbent period, where cuts of pepperoni are enclosed or wrapped in two superior layers and four inferior layers of an absorbent material on a tray in a microwave oven to dry them. The difference of this technique compared to the present invention is that it requires a microwave oven to carry out the drying of pepperoni cuts to reach a temperature through the energy of the microwave oven of 85° C. Moreover it requires the inclusion of absorbent material to absorb fats and oils that sweat the pepperoni and thus generate a product with a low contents of fats and a crunchy texture.

The disadvantage of this method is that the first stage of “sweat” takes about 1 hour to 4 hours, then the pepperoni cuts are transferred to trays that are wrapped with four folds of absorbent material on the bottom and two folds of absorbent material on the top. This second stage is performed in a period of 2 to 4 hours, after which the cuts are treated with energy from the microwave oven at 85° C.

William T. Paulos and Gregory K. Choate in the United States patent U.S. Pat. No. 6,699,520, publish on bacon products in cuts of different sizes for different applications in food, where a binding component is included in order to maintain the bacon slices components binding due its own nature of the meat (thin slices of pork meat), and the size and thickness of the slices. In this method, a cooking method is performed in a microwave oven and no drying within the range of temperatures of 129.4 4° C. to 135° C., where after cooking, a product is obtained with a yield of 25% to 60% by weight, however, the characteristics of a toasted and crunchy texture of the product are not obtained as through the method of this invention.

Gale F. Kunert and Richard M. Herreid in the United States patent U.S. Pat. No. 6,391,355 describe a method to prepare crunchy bacon portions from thin slices of raw pork meat, where the cooking method is carried out under pressure in a container, the temperature increases from 122° C. to 127° C. at 10546.5 kg/m³ up to 14062 kg/m³ of vapor pressure, and the product remains under pressure from 30 to 60 minutes. The method described here is quite different from the one proposed by the present invention, as it does not indicate under what conditions or characteristics the cuts of meat are made, and the drying stage to obtain a crunchy and roasted product is carried out without the application of pressure in the invention.

Gale F. Kunert and Steven C. Wobschall, in the United States patent U.S. Pat. No. 6,630,194 refer to a method to prepare pepperoni or pepperoni flakes, where a mixture of the product is ground and mixed, and later the product mixture is placed in a container and heated to a temperature, thus producing the product. The excess fat is drained from the product and the product is dried in a tumble dryer where the moisture to protein ratio is 1.6:1, then the product is cooled, sorted and packaged. In an alternative embodiment, the product mixture is ground and mixed; then the product mixture is emulsified and stuffed into envelopes, later the product mixture is cooked in a smoke house, thus forming the product. The product is cooled, the envelope is removed from the product and the product is ground. Then the product is dried in drum dryers, obtaining a ratio of moisture to protein of 1.6:1.

The main difference between the method described above and the proposed invention is that the invention uses pieces of steak instead of a pasta, thus the solid product is sliced prior to the drying step in an oven to give it its crunchy and toasted texture; while in the method of the patent U.S. Pat. No. 6,630,194, the product enters the dryer in a state of a paste or suspension which helps the product to turn more easily in the drum dryer operating at a temperature of 126.5° C. to 148.7° C. where the product is cooked to some degree inside the dryer moisture is removed from it, giving a ratio of moisture to protein of 1.6:1 or less. The drum speed is adjusted according to the ratio of moisture to protein of 1.6:1 or less, and a water activity level of approximately 0.75 to 0.85 and a revolution of the drum of about 45 seconds to 90 seconds.

Obviously there are differences in the drying stage, as the method of the invention may use a gas or electric oven consisting of an upper heating panel or at least one lower heating panel and at least one lower heating panel, the method described in patent U.S. Pat. No. 6,630,194, uses a drum dryer and in general there are many differences over the whole method, because despite the method of said patent appears to have advantages in terms of elimination of some stages, particularly the fermentation and maturation, it does not explicitly state that the product obtained is toasted and crunchy, it apparently is a product that is typically cut into thin slices.

In addition to the applications and/or patents mentioned above, there were some that could be considered as prior art, such as U.S. patents U.S. Pat. No. 5,968,571, U.S. Pat. No. 6,042,871 and U.S. Pat. No. 6,117,466. However, the above are the closest in terms of the claimed subject matter.

On the other hand, Raul Robles Yllade, in the publication of the Mexican patent application MX-GT04000021A, describes a snack-type food based on dehydrated meat, which is characterized by having as main ingredient lean beef, which combined with other ingredients can vary its flavors. The method involves the steps of grinding lean beef, place it in a meat mixer for mixing with other ingredients, then a plastic strip is stuffed and frozen at −10° C.; the next step is to slice it into thin slices, spread them in a flat container with salt and lemon and leave it for 12 hours, then spread on a steel mesh, where they are sprinkled with a mixture of 1 kg of arbol chili pepper, 1 kg of guajillo chili, 1 kg of salt and 100 g of monosodium glutamate. Once they get dusted, they are put into the oven at 110° C. for one hour. Once the product is cooled off, it is packed. The disadvantage of this method is that a mixture of ingredients is to be carried out where to every kilo of meat 100 ml of water, 10 g of seasoning and other ingredients are added for about an hour, then it is stuffed in a plastic gut in order to prepare the meat snack, which is carried out over a longer preparation time. Additionally, the invention employs steak cuts instead of stuffed pasta.

Furtaw Louis F. in the publication of U.S. patent application US-2006222752, also discloses a method for preparing a food product based on meat, comprising the steps of forming the meat in bulk form, bulk cooking, slice the cooked bulk package in a plurality of slices with a thickness of not greater than 1 mm; dry the slices in a first drying step to produce partially dried slices, until the first and the second surface of dried slices are dry enough to allow them to be cut and put one on top of the other, without adhering substantially one to another. Apart from the partial drying of the slices, they go to a second drying stage. The disadvantage of this method is that the meat is mixed and later a lump is formed and sewn once the lump is formed.

Obviously there are differences in the preparation stage of the meat to be sliced later into slices and in the drying stage as the method of the invention takes advantage of the direction of the muscle fibers of the meat to slice the meat, in the method described in patent MXGT04000021, the meat is ground, mixed with other ingredients and then stuffed in a plastic gut and frozen at −10° C. to continue the slicing, which in the present invention allows eliminating some stages and as well as throughout the method to obtain a product with better texture and toasting.

### SUMMARY OF THE INVENTION

In view of the above mentioned and in order to offer a solution for the limitations encountered, the object of this invention is to provide a method for preparing a crunchy snack-type meat food product; the method includes the steps of cutting pieces of muscle in meat strips, wherein the cut is made in the direction of the muscle fibers of the pieces of muscle; pressing the meat strips together in parallel into a mold; freezing the meat strips in the mold to form a frozen block of meat strips; removing the frozen block of meat strips from the mold; slicing the frozen block transversely to the muscle fibers, thereby obtaining sheets, slices or flakes of meat; and dehydrating and cooking these thin sheets, slices or flakes of meat.

In general, the purpose is to provide a crunchy snack-type of meat that is healthy, nutritious, with natural ingredients and easily accessible to consumers.

### BRIEF DESCRIPTION OF THE FIGURES

The characteristic details of the present invention are described in the following paragraphs, together with the figures related to it, in order to define the objectives of this invention, but not limiting the scope of it.

FIG. 1 is a block diagram of a method to prepare a snack-type meat food according to this invention.

FIG. 2 is a picture that shows a way of squeezing meat strips in a mold in accordance with the method to prepare a snack-type meat food according to this invention.

FIG. 3 is a picture that shows a frozen block of meat strips obtained in accordance with the method to prepare a snack-type meat food according to this invention.

FIG. 4 is a picture that shows one or more slices or slice portions of a frozen block of meat strips placed in a mesh tray and obtained in accordance with the method to prepare a snack-type meat food according to this invention.

FIG. 5 shows a 15× microscope view of a sheet, slice or flake of meat obtained by the method for preparing a food product of a snack-type according to this invention.

FIG. 6 shows a 3.8× magnified view of a sheet, slice or flake of meat obtained by the method for preparing a food product of a snack-type according to this invention.

### DETAILED DESCRIPTION OF THE INVENTION

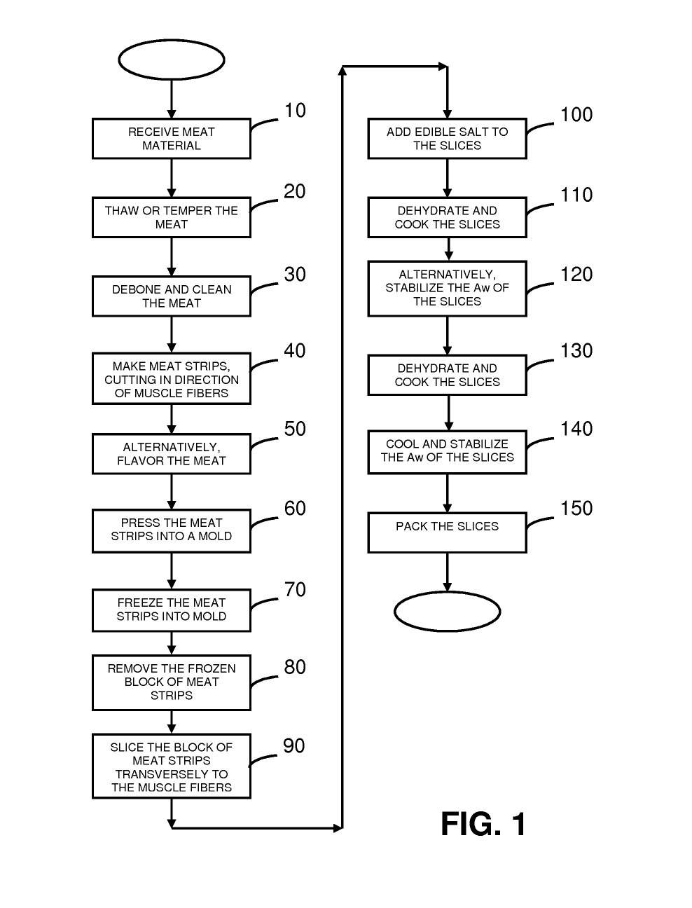

To carry out the method of the present invention, and referring to the block diagram shown in FIG. 1 in conjunction with the other figures, the method begins in step 10, where the raw material is received and basically comprises fresh or frozen meat, meaning the term “meat” usually referring to animal meat, such as beef, pork, chicken, lamb, turkey, fish or another meat combination of different animals. The meat, hereinafter referred to as muscle parts are inspected sensorially to ensure that these materials are suitable for their use, and to determine whether they require a period of thaw or not.

In one embodiment of the invention, the pieces of muscle basically contain beef of a cutting type, for example, white pulp, eye round roast, or the English denomination “gooseneck” (which is meat cut from the back or front leg of the cow, after removing the bone), containing approximately 80% to 95% meat (considering a waste of ligaments and skins of about 10%), the rest being fat and bone. These parts can be frozen at a temperature of about −38° C. to about 0° C. with a pH of 5.5 to 6.1.

In case the raw material consists of pieces of frozen muscle, in step 20, it is proceeded to a stage of thawing or tempering to a temperature of approximately 0° C. to 15° C. by the usual methods known in the art, while in case the raw material includes pieces of fresh muscle, these can be passed directly to the next stage of the invention.

Once thawed or not, the pieces of muscle are passed to the deboning and cleaning operation in step 30, to obtain muscle parts clean of fat, ligaments, cartilage and any other item that is not appropriate for the final texture of the snack-type food of meat the invention, as well as semi-lean cuts or cuts that can by their color and/or taste may be destined to the method of the invention. The muscle pieces, once cleaned, present a meat content of about 90% to 98% of meat, the rest being fat and/or moisture.

Both in the defrosting operation as in the boning operation, the returns of the operation are determined. In the case of the boning operation, this is carried out controlling the amount of surface fat, while the defrosting operation is carried out to determine the amount of fluid lost in the operation.

Once the pieces of muscle have been cleaned, in step 40, the pieces of muscle in meat strips, making the cuts in the direction of the muscle fibers of the pieces of muscle. Each of the meat strips obtained may have a cross section of a rectangular, oval, circular or irregular form with an area of 4 cm² to 64 cm² and a length of 5 cm to 40 cm, however, the length thereof is not of the main important issue, as it is simply recommended to use the entire length of the piece of muscle. The embodiment of this type of cuts into strips allows a smooth consistency of meat that later allows for a uniform slicing of said meat.

In an alternative embodiment, in step 50 these meat strips can be flavored according to the taste you want to give the snack, adding edible salt (sodium chloride, potassium chloride or sodium phosphate, which can be used independently or in combinations), pepper, chili, colorant (e.g., natural caramel), smoke, preservatives (e.g. sodium phosphates, curing salt) or other seasoning or mixtures thereof. These spices can be dry and/or wet base in order to be able to enter and permeate in the best way in the meat strips.

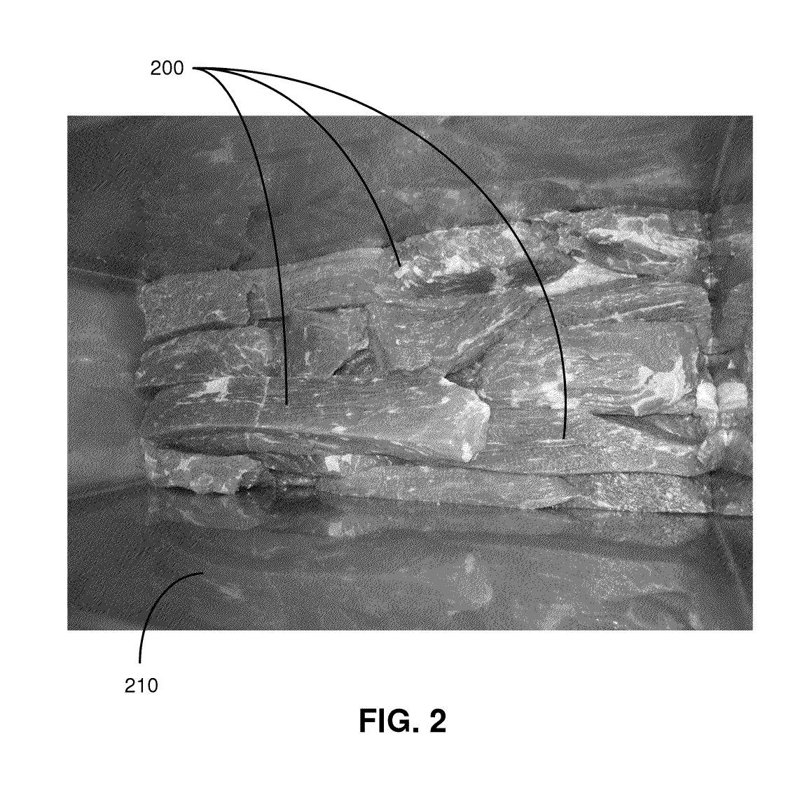

Then, in step 60, it is proceeded to press the meat strips together in parallel into molds, which can have the form of a cube, parallelepiped, cylinder or open-faced prism and can be of metal, aluminum or stainless steel with sizes ranging from 10 cm×10 cm×10 cm to 50 cm×50 cm×50 cm, however, the dimensions of the mold are not critical, because molds can simply be of the appropriate dimensions for its operation or manual or automated handling. The meat strips are packed into the mold while retaining the same direction, that is, packing generally parallel along the mold while retaining the muscle fiber direction of the meat strips, as shown in FIG. 2 where the steak strips 200 are placed in the mold 210. Once the mold is full, the meat strips are packed together by applying a pressure of 4750 Pa (0.689 psi) to 11870 Pa (1.723 psi) that can be exercised, for example, by a hydraulic piston, by a weight or a spring lid mechanism that relies on the open face of the mold. This pressure is exerted for a time necessary to reach an internal temperature in the meat strips group of −8° C. to −1° C. The compaction of the meat strips in the mold is made to fit in the mold all the meat strips and avoid gaps or spaces between these, obtaining a block of uniform meat strips that can be frozen. This molding and compaction can be performed at room temperature or a temperature between 5° C. to 16° C.

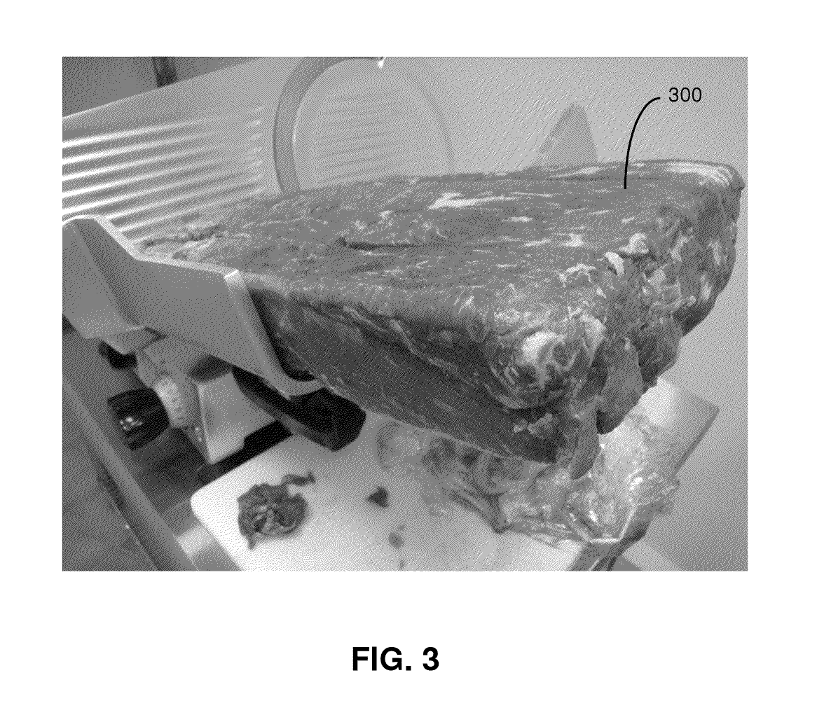

Subsequently, in step 70, the molds filled with meat strips are frozen in a cooling chamber at a temperature of −48° C. to −15° C. for a time depending on the type and capacity of said chamber in order to form a frozen block of meat strips of a stable consistency and an internal temperature of −8° C. to −1° C., so as to allow cutting in slices easily at the time of cutting the block, an example of the frozen block 300 of meat strips as a result can be observed in FIG. 3. The freezing stage coupled with compaction of the previous stage causes the meat strips packed into the mold from sticking together, forming a frozen block of meat strips in the same direction with a stable and suitable consistency for handling.

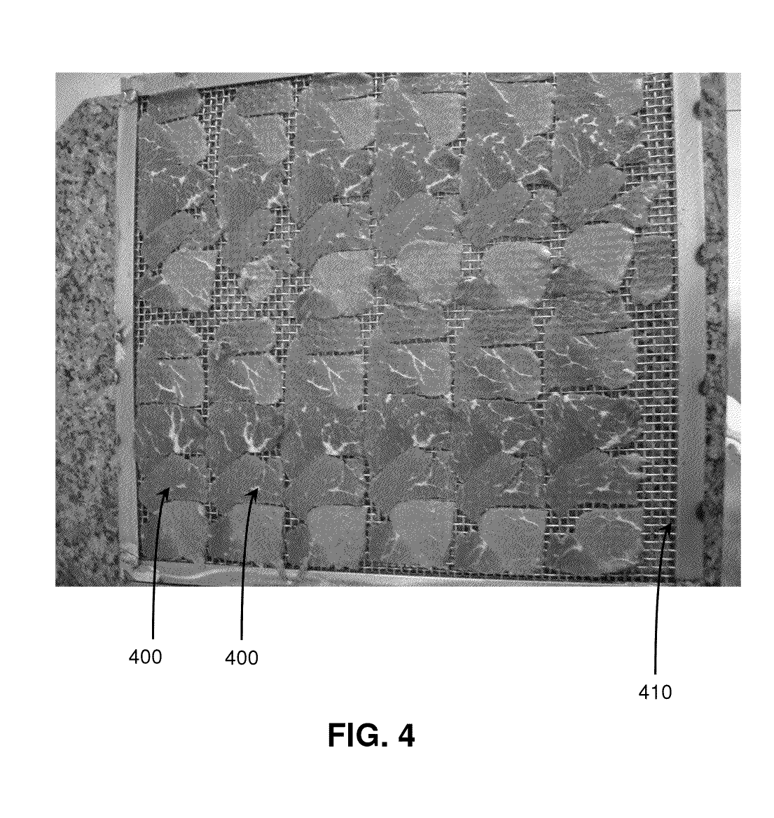

Once the block of meat strips has been frozen, it will be removed from the mold in step 80, and next, in step 90 is sliced transversely to the muscle fibers, that is, in the transverse direction along the axis of the block, cutting slices with a thickness of about 0.5 mm to 6 mm. As the block of meat strips is sliced and depending on the thickness of the slice, by the effect of the saw or cutting blade sheets, slices or flakes of thin and frozen, semi-frozen meat can be released (from 0.5 mm to 6 mm thick and from 1.6 g/slice up to 2.0 g/slice) that have their origin in the meat strips were packed, compacted and frozen in blocks, or portions or complete slices obtained formed by a group of frozen and thin sheets, slices or flakes of meat, that are still joined at their edges in the same plane due to the effects of freezing (as shown in FIG. 4 wherein portions or slices 400 are placed on a mesh tray 410). In the latter case, the sheets, slices or flakes of meat that form the portion or the slice of the block can be detached by mechanical effects, or simple thawing or placement at room temperature of the portion or slice of the block.

The block of frozen meat strips can be sliced in a number of relatively thin slices in a slicing station that may include one or more blades that cut across the block, perpendicular to the fibers of the meat to produce a series of slices, each of which must have their faces of a stiff texture.

The sheets, slices or flakes of meat are placed on metal or plastic mesh trays or a conveyor chain, proceeding, in step 100 to add edible salt on the plates, slices or flakes of meat so as to make them a soluble protein in salt. The edible salt may be sodium chloride, potassium chloride or sodium phosphate, which can be used independently or in combinations. In order to make the sheets, slices or flakes of meat have a better flavor, while adding edible salt; seasonings can be added to them. The amount of edible salt added is from 0.5% to 5% by weight of salt, respect the weight of said sheets, slices or flakes of meat, leaving the sheets, slices or flakes of meat rest for 1 min to 20 min at room temperature for about 5° C. to 16° C.

Once the sheets, slices or flakes of meat have been salted, they are transported, either in trays or on the conveyor chain, inside an electric or gas oven, whether or not convection, which can be formed by a lower heating panel, or by a lower heating panel and an upper panel spaced between them at a distance greater than the thickness of said trays or the conveyor belt. This is where, in step 110, sheets, slices or flakes of meat inside the oven are submitted to a first stage of dehydration and cooking at a temperature of 60° C. to 225° C. with a residence time in said oven for 20 min to 80 min and/or to reach a value of Water Activity (Aw) of approximately less than 0.75.

Alternatively, in step 120, sheets, slices, or chips are left to rest for 10 min to 30 min at room temperature in order to stabilize its Aw, then next it is proceeded, in step 130 to a second stage of dehydration and cooking in the electric or gas oven at a temperature of 60° C. to 225° C. with a residence time in said oven of 10 min to 30 min and/or to reach a Aw value of approximately less than 0.65.

Subsequently, in step 140, the sheets, slices, or flakes of meat are removed from the oven, letting them rest again for 10 min to 20 min at room temperature in order to cooling the product and stabilizing its Aw value to achieve a temperature of not higher than 35° C. and a Aw value less than 0.55 at a temperature of 25° C.

Finally, in step 150, varying amounts of sheets, slices or flakes of flesh are packed for their final consumption, for example, a BOPP film (biaxially oriented polypropylene) 25/25 (laminated) of a high barrier, and to which a gas can be injected consisting of approximately 70% nitrogen and 30% carbon dioxide.

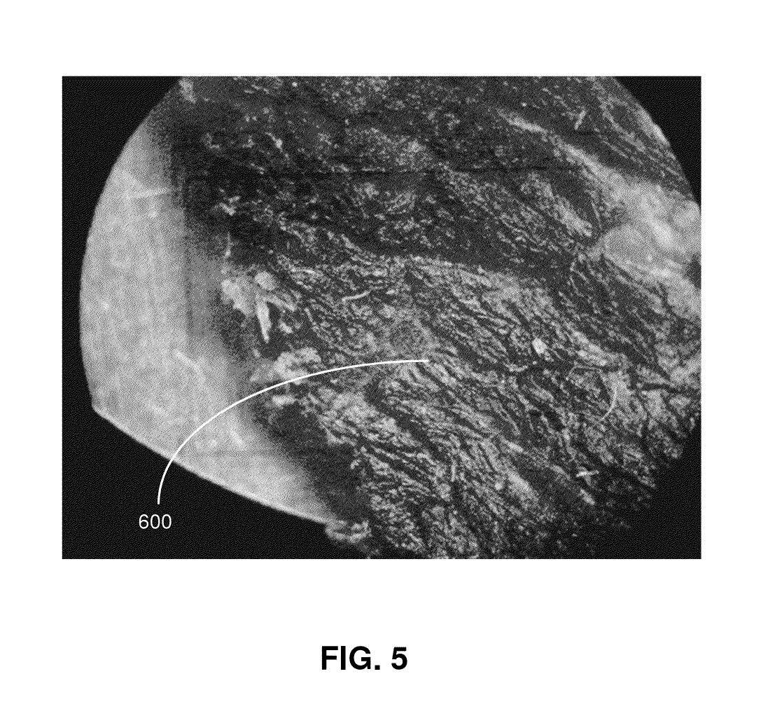

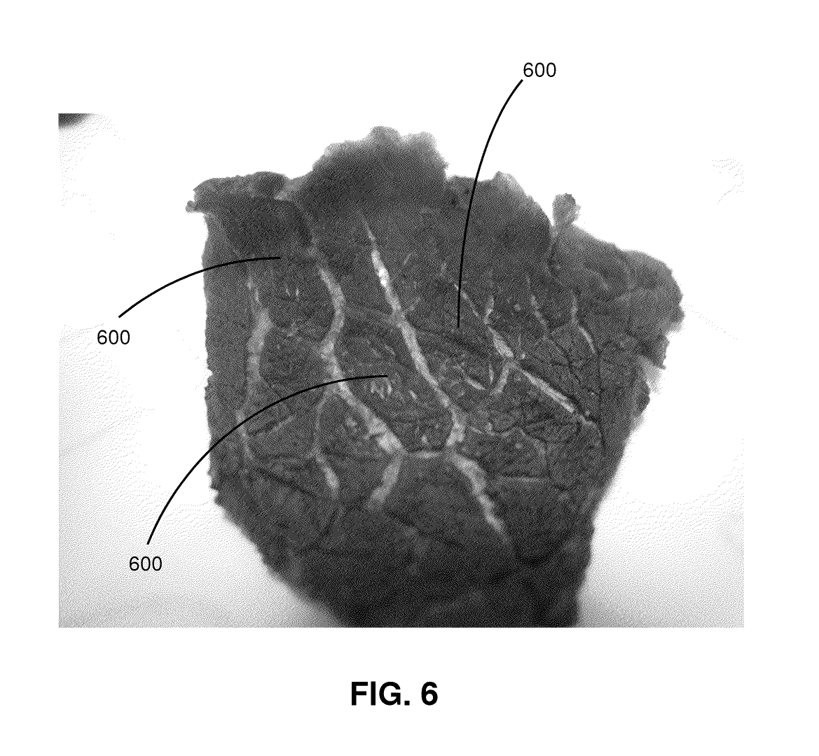

Under the method conditions listed above, as illustrated in FIGS. 5 and 6, a meat food product of a snack-type is obtained in sheets, slices or flakes of meat that are roasted and crunchy, showing a uniform and granulated consistency by transverse portions of muscle fibers 600 caused by the cross section cut of the strip of meat associated with said sheet, slice or flake and whose organoleptic characteristics are: a crisp texture, light to dark brown color, distinctive flavor of dry meat or dehydrated with the flavor of natural meat, or of the used seasoning. It also presents the characteristics listed in Table 1.

TABLE 1

| | | Result % dry | Result % wet |
|---|---|---|---|
| Parameter | Analysis Method | basis (db) | basis (wb) |
| Humidity | AOAC 925.10 | NA | From 9 to 11 |
| | (1992) | | |
| Ashes | AOAC 923.03 | From 7 to 8 | From 6 to 7.5 |
| | (1992) | | |
| Proteins | AOAC 978.02 | From 50 to 60 | From 50 to 55 |
| | (1992) | | |
| Fats | Goldfisch | From 9 to 15 | From 8 to 13.5 |
| Crude fiber | AOAC (1998) | From 0.10 to 0.40 | From 0.10 to 0.35 |
| Carbohydrates | Differential | From 18 to 21 | From 16 to 25 |
| Calories | Atwater | NA | From 370 |
| | coefficient | | kcal/100 g |
| | | | to 410 kcal/100 g |
| Aw | AOAC 978.18 | NA | From 0.24 to 0.55 |
| | (1990) | | |

Comments:
NA = Not Applicable
Acronyms in English AOAC = Association of Analytical Communities

### EXAMPLES OF EMBODIMENTS OF THE INVENTION

The invention will now be described in reference to the following examples, which is solely for the purpose of presenting the way of carrying out the implementation of the principles of the invention. The following examples do not intend to be a comprehensive representation of this invention, neither to limit the scope of said invention.

### Example 1

A piece of fresh muscle of 10 kg of white pulp and free from bones and fat, ligaments and cartilage in order to obtain a piece of muscle with a moisture content of about 59.4%, an amount of about 12% fat and approximately 28.6% of meat. The piece of muscle is tempered at a temperature of 8° C. Then the piece of muscle is cut in about 25 meat strips of cross section of approximately 4 cm×4 cm, an approximate length of 12 cm to 38 cm and weighing approximately 0.4 kg each. The cut is made in the direction of the muscle fibers of the pieces of muscle.

The 25 meat strips are squeezed into a stainless steel mold in a parallelepiped form with internal dimensions of 20 cm×50 cm×20 cm. The meat strips are squeezed into the mold while maintaining the same direction. Next, the meat strips are packed into the mold at a pressure of 5515.81 Pa (0.8 psi) using a lid with springs. This molding is performed at a temperature of 7° C.

Subsequently, the mold filled with meat strips is frozen in the refrigerator of the commercial brand Whirlpool model M-ET2OPM at a temperature of −18° C. for 8 hours to form a frozen block of meat strips of a stable consistency of an approximate weight of 9.2 kg and an internal temperature of −2.2° C.

Once the block of meat strips has been frozen, it will removed from the mold and then sliced transversely to the muscle fibers in a trademark Berkel commercial slicer, model M-827 E. The slices were cut with a thickness of 1.25 mm, thus yielding approximately 9 kg of sheets, slices or flakes of meat with a thickness of 1.25 mm and a section of approximately 16 cm².

The sheets, slices or flakes of meat are placed on a stainless steel mesh tray, proceeding to add 2.5% by weight of edible salt and chili-lime flavoring in relation to the total weight of the sheets, slices or flakes of meat. The sheets, slices or flakes of meat with salt are left to rest for 15 min at a room temperature of 25° C.

Subsequently the plates, slices or flakes of meat are introduced into a commercial oven, Modern Maid brand, model DGO0757UWW for the first stage of dehydration and cooking at a temperature of 100° C. for 35 min to reach a Aw value smaller than 0.75.

Then, the sheets, slices or flakes of meat, once dehydrated and cooked, are removed from the oven, and left to rest for 6 min at room temperature of 25° C., and then proceeded to a second stage of dehydration and cooking in the same oven of a temperature of 85° C. for 15 min to reach a Aw value smaller than 0.30.

The sheets, slices or flakes of roasted and crunchy meat obtained in this example according to the method of the invention have the following properties shown in Table 2.

TABLE 2

| | | Result % dry | Result % wet |
|---|---|---|---|
| Parameter | Analysis Method | basis (db) | basis (wb) |
| Humidity | AOAC 925.10 | NA | 9.10 |
| | (1992) | | |
| Ashes | AOAC 923.03 | 7.89 | 7.17 |
| | (1992) | | |
| Proteins | AOAC 978.02 | 55.59 | 50.53 |
| | (1992) | | |
| Fats | Goldfisch | 9.45 | 8.59 |
| Crude fiber | AOAC (1998) | 0.16 | 0.15 |
| Carbohydrates | Differential | 20.07 | 24.61 |
| Calories | Atwater coefficient | NA | 377.8 kcal/100 g |
| | | | 1580.9 kJ/100 g |
| Aw | AOAC 978.18 | NA | 0.248 |
| | (1990) | | |

Comments:
NA = Not Applicable
Acronyms in English AOAC = Association of Analytical Communities

### Example 2

Three pieces of fresh muscle of 4 kg of steak cleaned of fat, ligaments and cartilage in order to obtain a piece of muscle with a moisture content of about 59.4%, an amount of about 12% fat and an amount of approximately 28.6% meat. The piece of muscle is tempered at a temperature of 8° C. Then cut the piece of muscle in about 15 meat strips in cross-section of approximately 4.5 cm×5 cm, a length of approximately 25 cm and weighing about 1 kg each. The cut is made in the direction of the muscle fibers of the pieces of muscle.

The 15 meat strips are squeezed into a stainless steel mold of a parallelepiped form with internal dimensions of 25 cm×15 cm×25 cm. The meat strips are squeezed into the mold while maintaining the same direction. Then the meat strips are squeezed into the mold at a pressure of 6205.28 Pa (0.9 psi) using a lid with springs. This molding is performed at a temperature of 8° C.

Subsequently, the mold filled with meat strips is frozen in a Whirlpool brand commercial refrigerator, model M-ET2OPM at a temperature of −4° C. for 8 hours to form a frozen block of meat strips with a stable consistency of an approximate weight of 12 kg and an internal temperature of −2.5° C.

Once the block of meat strips has been frozen, it will be removed from the mold and then sliced transversely in the muscle fibers by a Berkel brand slicer, model M-827 E. The slices were cut with a thickness of 1.35 mm, thus yielding approximately 12 kg of sheets, slices or flakes of meat with a thickness of 1.35 mm and approximately a section of 22.5 cm².

The sheets, slices or flakes of meat are placed on a stainless steel mesh tray, proceeding to add 2.6% by weight of edible salt in relation to the total weight of the sheets, slices or flakes of meat. The sheets, slices or flakes of meat with salt are left to rest for 18 min at a room temperature of 25° C.

Subsequently the sheets, slices or flakes of meat are introduced into a commercial Modern Maid brand furnace, model DG00757UWW model for a first stage of dehydration and cooking at a temperature of 95° C. for 35 min to reach an approximate Aw value less than 0.86.

Then, the sheets, slices or flakes of meat once dehydrated and cooked, are removed from the oven, left to rest for 6 min at a room temperature of 25° C., and then proceed to a second stage of dehydration and cooking in the oven at a temperature of 85° C. for 14 min to reach an approximate Aw value less than 0.30.

The sheets, slices or flakes of roasted and crunchy meat obtained in this example according to the method of the invention have the following properties shown in Table 3.

TABLE 3

| | | Result % dry | Result % wet basis |
|---|---|---|---|
| Parameter | Analysis Method | basis (db) | (wb) |
| Humidity | AOAC 925.10 | NA | 10.14 |
| | (1992) | | |
| Ashes | AOAC 923.03 | 7.07 | 6.36 |
| | (1992) | | |
| Proteins | AOAC 978.02 | 59.42 | 53.4 |
| | (1992) | | |
| Fats | Goldfisch | 14.53 | 13.05 |
| Crude fiber | AOAC (1998) | 0.35 | 0.31 |
| Carbohydrates | Differential | 18.98 | 17.05 |
| Calories | Atwater coefficient | NA | 399.3 kcal/100 g |
| | | | 1670.6 kJ/100 g |
| Aw | AOAC 978.18 | NA | 0.249 |
| | (1990) | | |

Comments:
NA = Not Applicable
Acronyms in English AOAC = Association of Analytical Communities

While the invention has been disclosed and described with reference to a limited number of modes, it will be apparent that variations and modifications can be made to said invention without separating from the spirit and scope of the invention and other modifications may occur to those skilled in the art. Therefore, the following claims intend to cover modifications, variations and equivalents to said invention.

1. A method for preparing a crunchy snack-type meat food product, comprising the steps of:
cutting pieces of muscle in meat strips, wherein the cut is made in the direction of the muscle fibers of said pieces of muscle;
pressing the meat strips together in parallel into a mold;
freezing the meat strips in the mold to form a frozen block of meat strips;
removing the frozen block of meat strips from the mold;
slicing the frozen block transversely to the muscle fibers, thereby obtaining sheets, slices or flakes of meat; and
dehydrating and cooking said sheets, slices or flakes of meat.

2. The method of claim 1, wherein said meat is selected from a group consisting of meat from beef, pork, chicken, lamb, turkey, fish and combinations thereof.

3. The method of claim 1, wherein said meat strips have a cross section of a rectangular, oval, circular or irregular form with an area of 4 cm² to 64 cm² and a length of 5 cm to 40 cm.

4. The method of claim 1, wherein further said step of pressing the meat strips together in parallel into a mold, includes the step of compacting the meat strips at a pressure of 4.750 Pa to 11.870 Pa.

5. The method of claim 1, wherein in the step of freezing the meat strips in the mold to form a frozen block of meat strips, said block of meat strips is frozen at a temperature of −48° C. to −15° C. until an internal temperature of −8° C. to −1° C. is reached.

6. The method of claim 1, wherein in the step of slicing said frozen block of meat strips transversely to the muscle fibers, thus obtaining slices of meat, and said meat slices have a thickness of 0.5 mm to 6 mm.

7. The method of claim 1, wherein the step of dehydrating and cooking said slices or flakes of meat is done in an oven at a temperature of 60° C. to 225° C. with a residence time in said oven for 20 min to 80 min and/or to reach a value of water activity (Aw) of less than 0.75.

8. The method of claim 1, wherein further between the steps of slicing the frozen block transversely to the muscle fibers, thereby obtaining sheets, slices or flakes of meat, includes the step of salting said slices or flakes of meat with 0.5% to 5% by weight of edible salt respect to the weight of said sheets, slices or flakes of meat.

9. The method of claim 1, wherein further after the step dehydrating and cooking said sheets, slices or flakes of meat, includes the steps of:
resting said sheets, slices or flakes of meat; and
dehydrating and cooking said sheets, slices or flakes of meat.

10. The method of claim 9, wherein the step of dehydrating and cooking said slices or flakes of meat is done in an oven at a temperature of 60° C. to 225° C. with a residence time in the oven for 20 min to 80 min and/or to reach a value of water activity (Aw) of less than 0.65.

11. The method of claim 9, wherein further includes the step of resting said sheets, slices or flakes of meat from 10 min to 20 min at room temperature until reaching a temperature of not higher than 35° C. and a value of water activity (Aw) smaller than 0.55 at a temperature of 25° C.

12. The method of claim 1, wherein said crunchy snack-type meat food product includes:
a moisture content of 9% to 11% by weight on wet base;
an ash content of 7% to 8% by weight on dry base and 6% to 7.5% on wet base;
a protein content of 50% to 60% by weight on dry base and 50% to 55% wet base;
a fat content of 9% to 15% by weight on dry base and 8% to 13.5% wet base;
a crude fiber content of 0.10% to 0.40% by weight on dry base and 0.10% to 0.35% on wet base;
a carbohydrate content of 18% to 21% by weight on dry base and 16% to 25% on wet base;
an energy content of 370 kcal/100 g to 410 kcal/100 g on wet basis; and
a value of water activity (Aw) less than 0.55 on a wet base at a temperature of 25° C.
